(19) United States
(12) Patent Application Publication
(10) Pub. No.: US 2025/0201853 A1
(43) Pub. Date: Jun. 19, 2025

(54) NONAQUEOUS ELECTROLYTE SECONDARY BATTERY, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Taro MOMOZAKI, Tsukuba-shi (JP); Yuichi SABI, Tsukuba-shi (JP)

(73) Assignee: SEKISUI CHEMICAL CO., LTD., Osaka (JP)

(21) Appl. No.: 18/846,435

(22) PCT Filed: Mar. 15, 2023
(86) PCT No.: PCT/JP2023/010171

§ 371 Date: Sep. 12, 2024

(30) Foreign Application Priority Data
Mar. 15, 2022 (JP) 2022-040273
Dec. 19, 2022 (JP) 2022-202527

(51) Int. Cl. H01M 4/62; H01M 4/02; H01M 4/36; H01M 4/505; H01M 4/525

(52) U.S. Cl. CPC H01M 4/625; H01M 4/366; H01M 4/505; H01M 4/525; H01M 2004/028

(57) ABSTRACT

A non-aqueous electrolyte secondary battery includes a positive electrode, a negative electrode, and a non-aqueous electrolyte solution disposed between the positive electrode and the negative electrode, wherein: the positive electrode includes a current collector and a positive electrode active material layer provided on the current collector, the current collector has, on at least a part of its surface on a side of the positive electrode active material layer, a current collector coating layer comprising a conductive material, the positive electrode active material layer includes positive electrode active material particles and a conductive carbon, and the positive electrode active material layer has surface element ratios wherein C/M, which represents a ratio of carbon element C to metal element M excluding Group 1 elements and Group 2 elements of the periodic table, is 3.0 to 15.0.

### TECHNICAL FIELD

The present invention relates to a positive electrode for a non-aqueous electrolyte secondary battery, a battery module, and a battery system.

Priorities are claimed on Japanese Patent Application No. 2022-040273, filed Mar. 15, 2022, and Japanese Patent Application No. 2022-202527, filed Dec. 19, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

It is known that non-aqueous electrolyte secondary batteries not only deteriorate as a result of repeated charging and discharging, but also deteriorate while they are stored in a charged state (see, for example, Patent Document 1).

### PRIOR ART DOCUMENT

### Patent Document

Patent Document 1: Japanese Patent Granted Publication No. 6953649

### SUMMARY OF THE INVENTION

### Problems to be Solved by the Invention

An object of the present invention is to reduce deterioration of a non-aqueous electrolyte secondary battery during storage thereof (hereinafter referred to as “storage deterioration”).

### Means for Solving the Problems

The embodiments of the present invention are as follows.

[1] A non-aqueous electrolyte secondary battery, comprising a positive electrode, a negative electrode, and a non-aqueous electrolyte solution disposed between the positive electrode and the negative electrode, wherein:
the positive electrode comprises a current collector and a positive electrode active material layer provided on the current collector,
the current collector has, on at least a part of its surface on a side of the positive electrode active material layer, a current collector coating layer comprising a conductive material,
the positive electrode active material layer comprises positive electrode active material particles and a conductive carbon, and
the positive electrode active material layer has surface element ratios wherein C/M, which represents a ratio of carbon element C to metal element M excluding Group 1 elements and Group 2 elements of the periodic table, is 3.0 to 15.0, 5.0 to 14.0, or 7.0 to 13.0, and M/(S+N), which represents a ratio of the metal element M to a sum of sulfur element S and nitrogen element N, is 1.0 to 5.0, 1.5 to 4.5, or 2.0 to 4.0.
   [2] The non-aqueous electrolyte secondary battery according to [1], wherein the positive electrode active material particles comprise coated particles having a core section formed of a positive electrode active material and a coating section containing a conductive material.
   [2] The non-aqueous electrolyte secondary battery according to [2], wherein the conductive material of the coating section comprises carbon.
   [4] The non-aqueous electrolyte secondary battery according to any one of [1] to [3], wherein the positive electrode active material particles, on surfaces thereof, the coating section which has a peak in a range of 280 to 290 eV in a TEM-EELS spectrum resulting from combination of a transmission electron microscope (TEM) with electron energy loss spectroscopy (EELS), and has a ratio P285/P280 of 10.0 or more, or 100.0 or more, which is a ratio of a peak intensity P285 at 285 eV to a peak intensity P280 at 280 eV in the TEM-EELS spectrum.
   [5] The non-aqueous electrolyte secondary battery according to any one of [1] to [4], wherein, with respect to the surface element ratios, S/N, which represents a ratio of sulfur element S to nitrogen element N, is 0.01 to 1.00, 0.1 to 0.9, 0.3 to 0.8 or 0.55 to 0.7.
   [6] The non-aqueous electrolyte secondary battery according to any one of [1] to [5], wherein M/(S+N) is 3.0 to 4.0.
   [7] The non-aqueous electrolyte secondary battery according to any one of [1] to [6], wherein the positive electrode active material layer comprises a conducting agent.
   [8] The non-aqueous electrolyte secondary battery according to any one of [1] to [6], wherein an amount of the conductive carbon is 0.5% by mass or more and less than 3.0 by mass, preferably 1.0 to 2.8% by mass, more preferably 1.2 to 2.6.
   [9] The non-aqueous electrolyte secondary battery according to any one of [2] to [8], wherein an amount of the conductive material is 1.0 to 3.0% by mass, or 1.8 to 3.0% by mass, or 2.3 to 3.0% by mass, based on a total mass of the positive electrode active material particles.
   [10] The non-aqueous electrolyte secondary battery according to any one of [1] to [9], wherein the positive electrode active material particles comprise a compound represented by a formula LiFeₓM₍₁₋ₓ₎PO₄, wherein 0≤x≤1, M is Co, Ni, Mn, Al, Ti or Zr.
   [11] The non-aqueous electrolyte secondary battery according to any one of [1] to [10], wherein the conductive material of the current collector coating layer comprises carbon.
   [12] A battery module or battery system including a plurality of the non-aqueous electrolyte secondary batteries of any one of [1] to [11].

### Effect of the Invention

The present invention can reduce storage deterioration of a non-aqueous electrolyte secondary battery.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

### EMBODIMENTS TO CARRY OUT THE INVENTION

In the present specification and claims, “to” indicating a numerical range means that the numerical values described before and after “to” are included as the lower limit and the upper limit of the range.

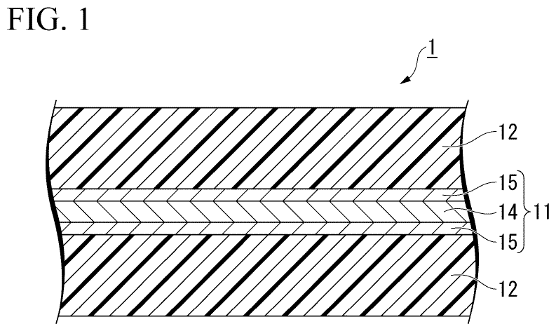

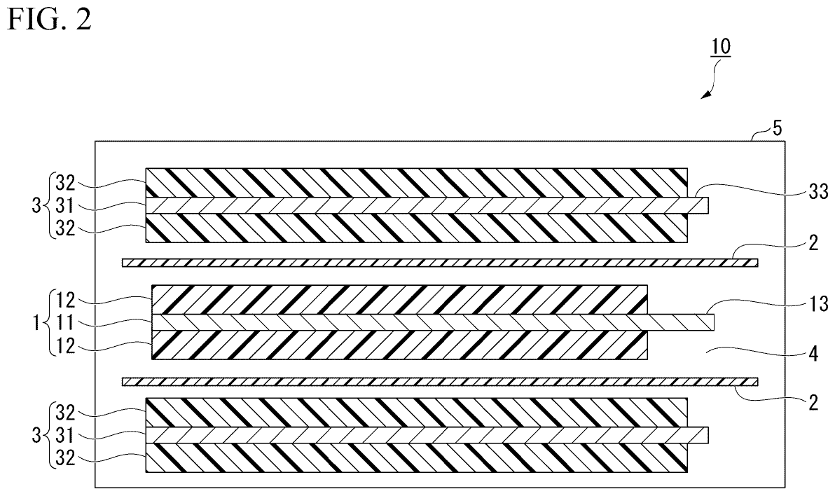

FIG. 1 is a schematic cross-sectional view showing one embodiment of a positive electrode for a non-aqueous electrolyte secondary battery according to the present invention. FIG. 2 is a schematic cross-sectional view showing one embodiment of a non-aqueous electrolyte secondary battery according to the present invention.

FIG. 1 and FIG. 2 are schematic diagrams for facilitating the understanding of the configurations, and the dimensional ratios and the like of each component do not necessarily represent the actual ones.

The non-aqueous electrolyte secondary battery of the present embodiment includes a positive electrode, a negative electrode, and a non-aqueous electrolyte solution present between the positive electrode and the negative electrode.

### <Positive Electrode for Non-Aqueous Electrolyte Secondary Battery>

The positive electrode 1 of the present embodiment (also simply referred to as “positive electrode”) has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

The positive electrode current collector 11 has current collector coating layers 15 on its surfaces facing the positive electrode active material layers 12. That is, the positive electrode current collector 11 has a positive electrode current collector main body 14 and current collector coating layers 15 that cover the positive electrode current collector main body 14 on its surfaces facing the positive electrode active material layers 12.

### [Positive Electrode Active Material Layer]

The positive electrode active material layer 12 includes positive electrode active material particles. The amount of the positive electrode active material particles is preferably 80.0 to 99.9% by mass, and more preferably 90 to 99.5% by mass, based on the total mass of the positive electrode active material layer 12.

The positive electrode active material layer 12 preferably further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material. The conducting agent is present independently of the positive electrode active material particles. The positive electrode active material layer 12 may further include a dispersant.

The thickness of the positive electrode active material layer is preferably 30 to 500 μm, more preferably 40 to 400 μm, particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging. When the positive electrode active material layers are present on both sides of the positive electrode current collector, the thickness of the positive electrode active material layer is the total thickness of the two layers located on both sides.

### [Positive Electrode Active Material Particles]

The positive electrode active material particles include a positive electrode active material. At least a part of the positive electrode active material particles is preferably a coated particle.

In the coated particles, a coating section containing a conductive material (hereinafter, also referred to as “active material coating section”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the present specification is not one newly formed in the steps following the preparation step of a positive electrode composition. In addition, the active material coating section is not one that comes off in the steps following the preparation step of a positive electrode composition.

For example, the active material coating section stays on the surface of the positive electrode active material even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles.

That is, the coated particles have a core section that is a positive electrode active material and an active material coating section that covers the surface of the core section, and the area ratio (i.e., coverage) of the coated section with respect to the surface area of the core section is preferably 50% or more, more preferably 70% or more, and even more preferably 90% or more. The upper limit of the coverage is not particularly limited, but for example, preferably 94% or less, more preferably 97% or less, even more preferably 100% or less. The coverage is preferably 50 to 94%, more preferably 70 to 97%, even more preferably 90 to 100%.

Examples of the method for producing the coated particles include a sintering method and a vapor deposition method.

Examples of the sintering method include a method that sinters an active material composition containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, sucrose, glucose, lactose, malic acid, citric acid, allyl alcohol, propargyl alcohol, ascorbic acid, and polyvinyl alcohol. With respect to these substances, a mixture of two or more kinds may be used, and an organic substance other than those listed above may also be used. This sintering method sinters an active material composition to allow carbon in the organic material to be fused to the surface of the positive electrode active material to thereby form the active material coating section.

Another example of the sintering method is the so-called impact sintering coating method.

The impact sintering coating method is carried out, for example, as follows. In an impact sintering coating device, a burner is ignited using a mixture of hydrocarbon fuel and oxygen, and a flame is generated by burning the mixture in a combustion chamber. In this process, the amount of oxygen is reduced to an amount equivalent to complete combustion of the fuel or less to lower the flame temperature. A powder supply nozzle is installed behind the flame, and a solid-liquid-gas three-phase mixture consisting of a solution obtained by dissolving an organic matter for coating in a solvent, and a combustion gas is sprayed from the powder supply nozzle. By increasing the amount of combustion gas maintained at room temperature, the temperature of the sprayed fine powder is lowered, and the sprayed fine powder is accelerated at a temperature below the transformation temperature, sublimation temperature or evaporation temperature of the powder material, and is instantly sintered by impact to coat the particles of the positive electrode active material.

Examples of the vapor deposition method include a vapor phase deposition method such as a physical vapor deposition method and a chemical vapor deposition method, and a liquid phase deposition method such as plating.

The coverage can be measured by a method as follows. First, the particles in the positive electrode active material layer are analyzed by the energy dispersive X-ray spectroscopy (TEM-EDX) using a transmission electron microscope. Specifically, an elemental analysis is performed by EDX with respect to the outer peripheral portion of the positive electrode active material particles in a TEM image.

The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, preferably 5 nm to 50 nm. This thickness can be determined by the above-mentioned TEM-EDX used for the measurement of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

In the present embodiment, the area ratio of the active material coating section in the coated particles is particularly preferably 100% with respect to the surface area of the core section.

This ratio is an average value for all the positive electrode active material particles present in the positive electrode active material layer. As long as this average value is not less than the above lower limit value, the positive electrode active material layer may contain positive electrode active material particles without the active material coating section. When the positive electrode active material particles (hereinafter, also referred to as “single particles”) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer. When single particles are present in the positive electrode active material layer, the lower limit of the amount of single particles relative to the total amount of positive electrode active material particles is not particularly limited, but may be 0.1% by mass or more, 0.2% by mass or more, or 0.3% by mass or more. When single particles are present in the positive electrode active material layer, the amount of single particles relative to the total amount of positive electrode active material particles is preferably 0.3 to 30% by mass, more preferably 0.2 to 20% by mass, even more preferably 0.1 to 10% by mass. In one embodiment, it is preferred that single particles are not present in the positive electrode active material layer.

The conductive material of the active material coating section preferably contains carbon (i.e., conductive carbon). The conductive material may be composed only of carbon, or may be a conductive organic compound containing carbon and elements other than carbon. Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 4.0% by mass, more preferably 0.5 to 3.0% by mass, even more preferably 0.7 to 2.5% by mass, based on the total mass of the positive electrode active material particles having the active material coating section. Excessive amount of the conductive material is not favorable in that the conductive material may come off the surface of the positive electrode active material particles and remain as isolated conducting agent particles.

Conductive particles that do not contribute to the creation of conductive path may become a site where self-discharge of the battery starts or a cause of undesirable side reactions.

The positive electrode active material particles preferably contain a compound having an olivine crystal structure as a positive electrode active material.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder.

Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the crushing time in the crushing process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNiₓCo_{y}Al_{z}O₂ with the proviso that x+y+z=1), lithium nickel cobalt manganese oxide (LiNiₓCo_{y}Mn_{z}O₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide, as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active material particles may be coated particles having the active material coating section described above.

The amount of the compound having an olivine type crystal structure is preferably 50% by mass or more, preferably 80% by mass or more, and even more preferably 90% by mass or more, based on the total mass of the positive electrode active material. This amount may be 100% by mass. The amount of the compound having an olivine type crystal structure is preferably 50 to 100% by mass or more, preferably 80 to 100% by mass or more, and even more preferably 90 to 100% by mass or more, based on the total mass of the positive electrode active material. When the positive electrode active material particles have the coated section, the total mass of the positive electrode active material particles includes the mass of the coated section.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass. When the coated lithium iron phosphate particles are used, the amount of the coated lithium iron phosphate particles is preferably 50 to 100% by mass or more, more preferably 80 to 100% by mass or more, and even more preferably 90 to 100% by mass or more, based on the total mass of the positive electrode active material particles.

The thickness of the active material coating section of the positive electrode active material particles is preferably 1 to 100 nm.

The thickness of the coated section of the positive electrode active material particles can be measured by a method of measuring the thickness of the coated section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the coated section is 100 nm or less.

The average particle size of the positive electrode active material particles is preferably 0.1 to 20.0 μm, more preferably 0.5 to 15.0 μm. When two or more types of positive electrode active materials are used, the average particle size of each of such positive electrode active materials may be within the above range. When the positive electrode active material particles have the active material coating section, the average particle size of the positive electrode active material particles includes the thickness of the active material coating section.

When the average particle size is not less than the lower limit value of the above range, the dispersibility in the positive electrode composition is improved, and agglomerates are less likely to occur. On the other hand, when the average particle size is not more than the upper limit value of the above range, the specific surface area becomes appropriately large, making it easier to secure an area for reaction during charging and discharging. As a result, the resistance of the battery decreases, and input/output performance is less likely to deteriorate.

The average particle size of the positive electrode active material particles in the present specification is a volume-based median particle size measured using a laser diffraction/scattering particle size distribution analyzer.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The binder content relative to the total mass of the positive electrode active material layer is preferably 1.0% by mass or less, more preferably 0.8% by mass or less.

When the positive electrode active material layer contains a binder, the lower limit of the binder content relative to the total mass of the positive electrode active material layer is preferably 0.1% by mass or more, more preferably 0.3% by mass or more. When the positive electrode active material layer contains a binder, the binder content is preferably 0.1 to 1.0% by mass, more preferably 0.3 to 0.8% by mass or more.

### [Conducting Agent]

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer is, for example, preferably 4 parts by mass or less, more preferably 3 parts by mass or less, and even more preferably 1 part by mass or less, relative to 100 parts by mass of the positive electrode active material. It is particularly preferable that the positive electrode active material layer does not contain a conducting agent, and it is desirable that there are no isolated conducting agent particles (for example, isolated carbon particles).

When the conducting agent is incorporated into the positive electrode active material layer, the lower limit value of the amount of the conducting agent is appropriately determined according to the type of the conducting agent, and is, for example, more than 0.1% by mass, based on the total mass of the positive electrode active material layer. When a conducting agent is incorporated into the positive electrode active material layer 12, the amount of the conducting agent is preferably more than 0.1% by mass and 2.5% by mass or less, more preferably 0.1% by mass and 2.3% by mass or less, even more preferably 0.1% by mass and 2.0% by mass or less.

In the context of the present specification, the expression “the positive electrode active material layer does not contain a conducting agent” or similar expression means that the positive electrode active material layer does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

Conducting agent particles that do not contribute to the creation of conductive path may become a site where self-discharge of the battery starts or a cause of undesirable side reactions.

### [Dispersant]

The dispersant contained in the positive electrode active material layer 12 is an organic substance, and examples thereof include polyvinylpyrrolidone, polyvinyl alcohol, polyvinyl butyral, and polyvinylformal. With respect to these dispersants, a single type thereof may be used individually or two or more types thereof may be used in combination.

The dispersant contributes to improving the dispersion of particles in the positive electrode active material layer. On the other hand, when the dispersant content is too high, resistance is likely to increase.

The amount of the dispersant is preferably 0.5% by mass or less, more preferably 0.2% by mass or less, based on the total mass of the positive electrode active material layer.

When the positive electrode active material layer contains a dispersant, the lower limit of the amount of the dispersant is preferably 0.01% by mass or more, more preferably 0.05% by mass or more, based on the total mass of the liquid detergent. When the positive electrode active material layer contains a dispersant, the amount of the dispersant is preferably 0.01 to 0.5% by mass, more preferably 0.05 to 0.2% by mass or more.

### [Positive Electrode Current Collector Main Body]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 m.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

The positive electrode current collector main body 14 has, on at least a part of its surface, a current collector coating layer 15. The current collector coating layer 15 contains a conductive material.

In this context, the expression “at least a part of its surface” means 10% to 100%, preferably 30% to 100%, more preferably 50% to 100% of the area of the surface of the positive electrode current collector main body.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm.

The thickness of the current collector coating layer can be measured by a method that measures the thickness of the coating layer in a transmission electron microscope (TEM) image or a scanning electron microscope (SEM) image of a cross section of the current collector coating layer. The thickness of the current collector coating layer need not be uniform. It is preferable that the current collector coating layer 15 having a thickness of 0.1 m or more is present on at least a part of the surface of the positive electrode current collector main body 14, and the maximum thickness of the current collector coating layer is 4.0 μm or less.

### [Conductive Carbon Content]

In the present embodiment, the positive electrode active material layer 12 contains conductive carbon. Examples of the embodiment in which the positive electrode active material layer contains the conductive carbon include the following embodiments 1 to 3.

Embodiment 1: The positive electrode active material layer contains a conducting agent; and the conducting agent includes conductive carbon.

Embodiment 2: The positive electrode active material layer contains a conducting agent; the positive electrode active material particles have, on at least a part of surfaces thereof, an active material coating section containing a conductive material; and one or both of the conductive material in the active material coating section and the conducting agent includes conductive carbon.

Embodiment 3: The positive electrode active material layer does not contain a conducting agent; the positive electrode active material particles have, on at least a part of surfaces thereof, an active material coating section containing a conductive material; and the conductive material in the active material coating section includes conductive carbon.

The embodiment 3 is more preferable in that C/M and M/(S+N) in the preferable ranges described below are easily achievable.

The amount of the conductive carbon is preferably 0.5% by mass or more and less than 3.0 by mass, more preferably 1.0 to 2.8% by mass, even more preferably 1.2 to 2.6% by mass, based on the total mass of the positive electrode active material layer.

When the amount of the conductive carbon in the positive electrode active material layer is not less than the lower limit value of the above range, the amount is sufficient to forma conductive path in the positive electrode active material layer. When the amount is not more than the upper limit value described above, the dispersibility improves.

The amount of the conductive carbon relative to the total mass of the positive electrode active material layer can be calculated from the conductive carbon contents of the positive electrode active material particles and the conducting agent as well as the blended amount.

Further, the conductive carbon content based the total mass of the positive electrode active material layer can also be measured by <<Method for measuring conductive carbon content>> described below with respect to a dried product, as a measurement target, obtained by vacuum-drying, at 120° C., the positive electrode active material layer detached from the positive electrode.

For example, the measurement target may be one obtained by detaching the outermost surface of the positive electrode active material layer with a depth of several μm using a spatula or the like, and vacuum drying the resulting in an environment of 120° C.

The conductive carbon to be measured by the <<Method for measuring conductive carbon content>> described below includes carbon in the active material coating section and carbon in the conducting agent, but does not include carbon in the binder and carbon in the dispersant.

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: A temperature of the sample is raised from 30° C. to 600° C. at a heating rate of 10° C./min and holding the temperature at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a 1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( A 2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Temperature of combustion furnace: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2), molecular weight 64), the conductive carbon content can be calculated by the following formula from the fluoride ion (F₋) content (unit: % by mass) measured by combustion ion chromatography based on the tube combustion method, the atomic weight (19) of fluorine in the monomers constituting PVDF, and the atomic weight (12) of carbon in the PVDF.

$$PVDF content ( unit : \% by mass ) = fluoride ion content ( unit : \% by mass ) \times 64 / 38$$

$$PVDF - derived carbon amount M 4 ( unit : \% by mass ) = fluoride ion content ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

When the dispersant is contained, the conductive carbon content (unit: % by mass) can be obtained by subtracting M4 from M3, and further subtracting therefrom the amount of carbon belonging to the dispersant.

These methods are described in the following publications:

Toray Research Center, The TRC News No. 117 (September 2013), pp. 34-37, [Searched on Feb. 10, 2021], Internet <https://www.toray-research.co.jp/technical-info/trcnews/pdf/TRC117(34-37).pdf>

TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the active material coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the active material coating section. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer

### <Method for Producing Positive Electrode>

The present embodiment's method for producing the positive electrode 1 includes a composition preparation step of preparing a positive electrode composition containing a positive electrode active material, and a coating step of coating the positive electrode composition on the positive electrode current collector 11.

For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder. The positive electrode composition may contain a dispersant.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte solution. The non-aqueous electrolyte secondary battery 10 may further include a separator 2. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on apart of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing 5 such as an aluminum laminate bag, and a non-aqueous electrolyte solution is injected into the outer casing, followed by sealing the outer casing 5.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. The negative electrode active material layer 32 may further includes a binder. The negative electrode active material layer 32 may further include a conducting agent. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as natural graphite and artificial graphite, lithium titanate, silicon, silicon monoxide, and silicon oxides. Examples of the carbon materials include graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid, lithium polyacrylate, polyvinylidene fluoride, polyvinylidene fluoride-propylene hexafluoride copolymer, styrene-butadiene rubber, polyvinyl alcohol, polyethylene oxide, polyethylene glycol, carboxymethyl cellulose, polyacrylonitrile, polyimide, and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The sum of the amount of the negative electrode active material and the amount of the conducting agent relative to the total mass of the negative electrode active material layer 32 is preferably 80.0 to 99.9% by mass, more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte solution described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The thickness of the separator 2 is, for example, 5 to 50 μm.

The separator 2 may contain at least one of plasticizers, antioxidants, and flame retardants. Examples of the antioxidant include phenolic antioxidants such as hindered phenolic antioxidants, monophenolic antioxidants, bisphenolic antioxidants, and polyphenolic antioxidants; hindered amine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte Solution]

The non-aqueous electrolyte solution fills the space between the positive electrode 1 and the negative electrode 3. For example, any of known non-aqueous electrolyte solutions used in lithium ion secondary batteries, electric double layer capacitors and the like can be used.

The non-aqueous electrolyte solution used in the manufacture of the non-aqueous electrolyte secondary battery 10 contains an organic solvent, an electrolyte, and an additive.

After manufacture, especially after initial charging, the non-aqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrahydrofuran, 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, lithium hexafluoroarsenate, lithium trifluoroacetate, lithium bis(fluorosulfonyl)imide, and lithium bis(trifluoromethanesulfonyl)imide, or mixtures of two or more of these salts.

The additive is a compound that undergoes a decomposition reaction upon initial charging to form a coating on the surface of the positive electrode active material layer.

The additive includes at least a compound A that contains one or both of a sulfur atom and a nitrogen atom.

It is preferable that the compound A contains both a sulfur atom and a nitrogen atom. In addition to the compound A, one or more types of known additives may be included. With respect to such additives, a single type thereof may be used individually or two or more types thereof may be used in combination.

Examples of the compound A include lithium bis(fluorosulfonyl)imide (LiN(SO₂F)₂, hereafter also referred to as “LiFSI”) and lithium bis(trifluoromethanesulfonyl)imide (LiN(SO₂CF₃)₂, hereafter also referred to as “LiTFSI”).

The compound A may be one usable as an electrolyte, but different compounds are used for the electrolyte in the non-aqueous electrolyte solution and the compound A.

Examples of combinations of the compound A and the electrolyte salt include a combination of LiFSI and lithium hexafluorophosphate, and a combination of LiTFSI and lithium hexafluorophosphate.

The amount of compound A used can be set so as to obtain a coating film that satisfies C/M and M/(S+N) described below.

The total amount of the additive relative to the total amount of the non-aqueous electrolyte solution is preferably 0.1 to 2.0 mol/L, more preferably 0.3 to 1.0 mol/L.

### <Method for Producing Non-Aqueous Electrolyte Secondary Battery>

Examples of the method for producing a non-aqueous electrolyte secondary battery according to the present embodiment include a method in which a positive electrode, a separator, a negative electrode, a non-aqueous electrolyte solution, an exterior body, etc. are put together by a known method, followed by performing a charging (i.e., initial charge) at least once, to thereby obtain a non-aqueous electrolyte secondary battery. The initial charge allows a coating derived from the additive in the electrolyte to be formed on the surface of the positive electrode active material layer.

In the non-aqueous electrolyte secondary battery of the present embodiment, the analysis of the surface of the positive electrode active material layer detects at least the carbon element derived from the conductive carbon, the metal element derived from the positive electrode active material, and one or both of the sulfur element and the nitrogen element derived from the additive in the electrolyte solution, i.e., compound A.

In this context, since the concentrations of the elements of Groups 1 and 2 of the periodic table are easily variable in the non-aqueous electrolyte secondary battery, the proportion of the metal elements excluding these elements is used as the element ratio M in the present specification. In the present specification, the “periodic table” indicates the “long-form periodic table”.

Examples of the metal element M excluding the elements of Groups 1 and 2 of the periodic table include Fe, Co, Ni, Mn, Al, Ti, Zr, etc.

The sulfur element and the nitrogen element contained in the surface composition are preferably those derived from the additive in the electrolyte solution. In other words, it is preferable that the positive electrode active material particles do not contain either the sulfur element or the nitrogen element.

In terms of the surface element ratios of the positive electrode active material layer, C/M, which represents a ratio of carbon element C to metal element M, is 3.0 to 15.0, and M/(S+N), which represents a ratio of the metal element M to a sum of sulfur element S and nitrogen element N, is 1.0 to 5.0.

Preferably, C/M is 5.0 to 14.0, and M/(S+N) is 1.5 to 4.5.

More preferably, C/M is 7.0 to 13.5, and M/(S+N) is 2.0 to 4.0.

The surface element ratio of the positive electrode active material layer, i.e., the molar ratio, S/N, which represents a ratio of sulfur element S to nitrogen element N, is preferably 0.01 to 1.00, more preferably 0.1 to 0.9, even more preferably 0.3 to 0.3 to 0.8, particularly preferably 0.4 to 0.7.

The surface element ratio of the positive electrode active material layer in the present specification is measured by the following method.

### <<Sample Preparation Method>>

After at least initial charging, the non-aqueous electrolyte secondary battery is discharged while avoiding over-discharging, and the positive electrode to be measured is taken out and washed in an inert atmosphere. For example, the initial charging and discharging may be performed under the following conditions: charging at a constant current at a rate of 0.2 C and with a cut-off voltage of 3.6 V, charging at a constant voltage of 3.6 V until the current value dropped to 0.05 C, and then discharged at a constant current rate of 0.2 C and with a cut-off voltage of 2.0 V. The electrolyte solution adhering to the positive electrode is removed by immersing the positive electrode in diethyl carbonate or ethyl methyl carbonate as a cleaning solvent and allowing the resulting to stand for about 10 minutes, after which the cleaning solvent is drained once and the positive electrode is immersed in a new cleaning solvent and washed. The washed positive electrode is dried under reduced pressure at 25° C. to remove the cleaning solvent.

The dried positive electrode is used as a sample and analyzed.

### <<Sample Analysis Method>>

Various surface analysis instruments such as X-ray photoelectron spectrometers, Auger electron spectrometers, and glow discharge optical emission spectrometers can be used to determine the surface element ratio.

### <<Method for Determining Element Ratio on the Surface of the Positive Electrode Active Material Layer by XPS>>

With respect to the method for determining the element ratio on the surface of the positive electrode, an example using an X-ray photoelectron analyzer is described below. As an apparatus for this purpose, for example, KRATOS ULTRA2 manufactured by Shimadzu Corporation can be used.

With the X-ray source being monochromated Al-Karay (monochromated-Al-Kα) at 225 W and a take-off angle being 90°, measurement can be implemented while mitigating the charge build-up caused by the charge with a neutralizing gun. The measurement range may be approximately 300 μm×700 μm. Since no processing such as sputtering or ion milling is performed, the X-ray penetration depth may be, for example, 10 nm from the surface, and it is presumed that organic coatings and coating components on the surface are mainly detected.

In the measurement, the C(1s) peak obtained as indicating carbon element, the N(1s) peak obtained as indicating nitrogen element, the S(2p) peak obtained as indicating sulfur element, and peaks obtained as indicating metal elements other than elements in groups 1 and 2 of the periodic table (e.g., Fe(2p), Co(2p), Ni(2p), Mn(2p), Al(2p), Ti(2p), Zr(3d), etc.) can be measured.

While defining total value of the peak intensities of metal elements other than elements in groups 1 and 2 of the periodic table as “M”, the total value of the peak intensities of S(2p) and N(1s) as “(S+N)”, and the peak intensity of C(1s) as “C”, and the values of C/M, M/(S+N), and S/N can be calculated.

C/M is the ratio of the atomic concentration of carbon to the total atomic concentration of metal elements excluding Group 1 and Group 2 elements on the surface of the positive electrode active material layer.

M/(S+N) is the ratio of the total atomic concentration of metal elements excluding Group 1 and Group 2 elements to the total atomic concentration of sulfur and nitrogen elements on the surface of the positive electrode active material layer. S/N is the ratio of the atomic concentration of sulfur to the atomic concentration of nitrogen on the surface of the positive electrode active material layer.

In the surface element ratio of the positive electrode active material layer, when M/(S+N) is within the above range, a coating of an appropriate amount or thickness is allowed to be formed on the surface of the positive electrode active material layer, thereby providing an excellent effect of reducing storage deterioration. When M/(S+N) exceeds the upper limit of the above range, the amount of coating is insufficient. When M/(S+N) is below the lower limit of the above range, the amount of coating is too much, which is likely to lead to an increase in resistance. That is, when M/(S+N) is not more than the upper limit value of the above range, the amount of coating is sufficient, whereas when M/(S+N) is not less than the lower limit value of the above range, the amount of coating is not too much, which is likely to suppress an increase in resistance.

Further, when C/M is not less than the lower limit value of the above range, the resistance of the positive electrode is likely to be low, whereas when C/M is not more than the upper limit value, the amount of the coating is likely to be appropriate. That is, when C/M is not less than the lower limit value, the positive electrode active material layer is sufficiently carbon-coated, and the resistance is likely to be low due to the conductive carbon. When C/M is not more than the upper limit value, the amount of the coating is appropriate, and it is likely that the conductivity is not impaired and the resistance is low.

M/(S+N) and C/M can be adjusted by the presence or absence of the coating section of the positive electrode active material particles, the amount of conductive material present in the coating section of the positive electrode active material particles, the amount of the conducting agent, the amount of additive in the electrolyte solution, and the like.

For example, when the positive electrode active material particles have the coating section, excessive decomposition of the additive in the electrolyte solution is suppressed, and an appropriate amount of coating is likely to be obtained.

When the amount of conductive material present in the coating section of the positive electrode active material particles is small, the amount of coating tends to be large.

When the amount of the conductive assistant is large, the amount of coating tends to be large.

When the amount of the additive in the electrolyte solution is small, M/(S+N) tends to be large.

When the S/N ratio of the surface element ratio of the positive electrode active material layer is within the above range, a coating derived from the additive is formed desirably on the surface of the positive electrode active material layer, and the effect of reducing storage deterioration is easily obtained.

When the additive in the electrolyte solution contains the compound A containing both sulfur atoms and nitrogen atoms, the S/N ratio tends to be equal to or higher than the lower limit of the above range. When the positive electrode active material layer contains a small amount of sulfur atoms other than sulfur atoms derived from the additive in the electrolyte solution, such as impurities, the S/N ratio tends to be equal to or lower than the upper limit of the above range.

When the conductive material contained in the coating section of the positive electrode active material particles is conductive carbon, the TEM-EELS spectrum obtained by transmission electron microscopy-electron energy loss spectroscopy (TEM-EELS) with the positive electrode active material particles as the measurement target is an indicator of the presence or absence of the coating section on the positive electrode active material particles and the amount of conductive carbon present in the coating section.

Specifically, it is known that the TEM-EELS spectrum of a carbon material begins to rise at between 280 and 285 eV, and a peak due to sp² bonds appears at around 285 eV. Therefore, the presence of a peak in the range of 280 to 290 eV in the TEM-EELS spectrum of the positive electrode active material particles indicates the presence of a coating section containing conductive carbon.

Further, a larger value of P₂₈₅/P₂₈₀, which represents the ratio of the peak intensity P₂₈₅ at 285 eV to the peak intensity P₂₈₀ at 280 eV, indicates that a larger amount of conductive carbon is present in the coating section of the positive electrode active material particles.

In terms of facilitating the formation of an appropriate amount of coating on the surface of the positive electrode active material layer, P₂₈₅/P₂₈₀ is preferably 10.0 or more, more preferably 100.0 or more. The upper limit of P₂₈₅/P₂₈₀ is not particularly limited, and may be, for example, 1,000,000 or less or 100,000 or less. P₂₈₅/P₂₈₀ is preferably 10.0 to 1,000,000, more preferably 100.0 to 100,000.

The TEM-EELS spectrum of the positive electrode active material particles in the present specification is measured by the following method.

### <<TEM-EELS Spectrum Measurement Method for Positive Electrode Active Material Particles>>

The TEM-EELS analysis method is a method for analyzing the composition and electronic state of a material by measuring the energy lost when high-speed electrons pass through a sample.

The TEM-EELS spectrum measurement for positive electrode active material particles can be performed according to the following steps (1) to (5).

(1) The positive electrode active material layer is exclusively peeled off from the positive electrode with a spatula. In this process, care must be taken so as not to remove the current collector foil as well.
(2) The positive electrode active material layer obtained in (1) above is observed using a transmission electron microscope, such as HD2700 manufactured by Hitachi High-Tech Corporation.
(3) The transmission electron microscope-energy dispersive X-ray spectroscopy is implemented in advance to identify, as the positive electrode active material particle, one particle for which a peak of a metal derived from the positive electrode active material, such as Fe, is detected.
(4) EELS spectra are obtained for multiple observation points, for example 30 points, arbitrarily selected from the surface layer portion of the positive electrode active material particle identified in (3) and having a thickness of 100 nm or less. The measurement conditions for the EELS spectra are, for example, an acceleration voltage of high-speed electrons of 200 kV when using the Hitachi High-Tech's HD2700.
(5) For the EELS spectrum at each observation point, it is determined whether there is one or more peaks in the range of 280 to 290 eV that are significantly different from the baseline. When there is one or more such peaks at all observation points, it is determined that there is a peak in the range of 280 to 290 eV. In this context, a peak being “significant different” means a peak having an intensity of 0.001% or more when the “maximum value−minimum value” at the baseline is set to 100%.
(6) For the EELS spectrum at each observation point, the ratio of the peak intensity P285 at 285 eV to the peak intensity P280 at 280 eV is calculated, and the average value for all the observation points is taken as the measured value of the peak intensity ratio (P285/P280).

The present embodiment can reduce storage deterioration of a non-aqueous electrolyte secondary battery.

For example, as shown in the Examples section described later, when the battery is stored for 10 days under harsh conditions of 75° C. in a fully charged state, the resistance increase rate due to storage deterioration can be reduced to 150% or less, preferably 130% or less, more preferably 120% or less.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

Still another aspect of the invention includes the following.

[1] A non-aqueous electrolyte secondary battery, comprising a positive electrode, a negative electrode, and a non-aqueous electrolyte disposed between the positive electrode and the negative electrode, wherein:
the positive electrode comprises a current collector and a positive electrode active material layer provided on the current collector,
the current collector has, on at least a part of its surface on a side of the positive electrode active material layer, a current collector coating layer comprising a conductive material,
the positive electrode active material layer comprises positive electrode active material particles and a conductive carbon, and
the positive electrode active material layer has surface element ratios measured by X-ray photoelectron spectroscopy, wherein C/M, which represents a ratio of carbon element C to metal element M excluding Group 1 elements and Group 2 elements of the periodic table, is 3.0 to 15.0, and M/(S+N), which represents a ratio of the metal element M to a sum of sulfur element S and nitrogen element N, is 1.0 to 5.0.
   [2] The non-aqueous electrolyte secondary battery according to [1], wherein the positive electrode active material particles comprise coated particles having a core section formed of a positive electrode active material and a coating section containing a conductive material.
   [2] The non-aqueous electrolyte secondary battery according to [2], wherein the conductive material of the coating section comprises carbon.
   [4] The non-aqueous electrolyte secondary battery according to any one of [1] to [3], wherein the positive electrode active material particles, on surfaces thereof, the coating section which has a peak in a range of 280 to 290 eV in a TEM-EELS spectrum resulting from combination of a transmission electron microscope (TEM) with electron energy loss spectroscopy (EELS), and has a ratio P285/P280 of 10.0 or more.
   [5] The non-aqueous electrolyte secondary battery according to any one of [1] to [4], wherein, with respect to the surface element ratios, S/N, which represents a ratio of sulfur element S to nitrogen element N, is 0.01 to 1.00.
   [6] The non-aqueous electrolyte secondary battery according to any one of [1] to [5], wherein the positive electrode active material layer comprises a conducting agent.
   [7] The non-aqueous electrolyte secondary battery according to any one of [1] to [6], wherein an amount of the conductive carbon is 0.5% by mass or more and less than 3.0% by mass, based on a total mass of the positive electrode active material layer.
   [8] The non-aqueous electrolyte secondary battery according to any one of [1] to [7], wherein the positive electrode active material particles comprise a compound represented by a formula LiFeₓM₍₁₋ₓ₎PO₄, wherein 0≤x≤1, M is Co, Ni, Mn, Al, Ti or Zr.
   [9] The non-aqueous electrolyte secondary battery according to any one of [1] to [8], wherein the conductive material of the current collector coating layer comprises carbon.
   [10] A battery module or battery system including a plurality of the non-aqueous electrolyte secondary batteries of any one of [1] to [9].

### EXAMPLES

Hereinbelow, the present invention will be described with reference to Examples which, however, should not be construed as limiting the present invention.

### <Evaluation Method>

### [High-Temperature Storage Test in a Fully Charged State]

A high-temperature storage test in a fully charged state was performed according to the following steps (1) to (5), and the resistance increase rate was measured.

(1) The AC resistance of the non-aqueous electrolyte secondary battery, which was a laminate cell that had been initially charged and degassed to remove internally generated gas, was measured at a frequency of 1 kHz in a 25° C. environment, to determine the resistance value before storage.
(2) The battery was then charged to a fully charged state, and stored in a thermostatic chamber set at 75° C. for 10 days, i.e., 240 hours.
(3) The battery was removed from the thermostatic chamber and left to stand by for 2 hours in a 25° C. environment.
(4) Having confirmed the surface temperature being 25° C. using a thermometer, the AC resistance was measured at a frequency of 1 kHz in a 25° C. environment to determine the resistance value after storage.
(5) The resistance value after storage was divided by the resistance value before storage, and expressed as a percentage to determine the resistance increase rate.

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of an 8 μm-thick copper foil and vacuum dried at 100° C. Then, the resulting was pressure-pressed under a load of 2 kN to obtain a negative electrode sheet. The obtained negative electrode sheet was punched to obtain a negative electrode.

### Production Example 2: Production of Current Collector Having Current Collector Coating Layer

A slurry was obtained by mixing 100 parts by mass of carbon black, 40 parts by mass of polyvinylidene fluoride as a binder, and N-methylpyrrolidone as a solvent. The amount of N-methylpyrrolidone used was the amount required for applying the slurry.

The obtained slurry was applied to both sides of a 15 μm-thick aluminum foil (that is, positive electrode current collector main body) by a gravure method so as to allow the resulting current collector coating layers after drying to have a thickness of 2 μm in terms of a total thickness of layers on both sides of the positive electrode current collector main body, and dried to remove the solvent, thereby obtaining a positive electrode current collector. The current collector coating layers on both surfaces were formed so as to have the same amount of coating and the same thickness.

As the positive electrode active material particles, coated particles having a core section formed of lithium iron phosphate and a coating section formed of carbon (hereinafter referred to as “LFP coated particles”) and lithium nickel cobalt aluminate (hereinafter referred to as “NCA”) as a comparative example were used.

LFP coated particles (1): average particle size 1.1 μm, carbon content 1.5% by mass, coating coverage 90% or more.

LFP coated particles (2): average particle size 0.9 μm, carbon content 2.0% by mass, coating coverage 90% or more.

LFP coated particles (3): average particle size 1.1 μm, carbon content 2.5% by mass, coating coverage 90% or more.

LFP coated particles (4): average particle size 1.0 μm, carbon content 0.5% by mass, coating coverage 90% or more.

LFP coated particles (5): average particle size 1.0 μm, carbon content 1.5% by mass, coating coverage 90% or more.

NCA particles (1): average particle size 10.1 μm, no coating section, carbon content 0% by mass.

Carbon black was used as a conducting agent. Impurities are below the quantification limit; therefore, the carbon black can be regarded as having a carbon content of 100% by mass.

Polyvinylidene fluoride was used as a binder.

N-methylpyrrolidone was used as a solvent.

An aluminum foil with a current collector coating layer obtained in Example 2, or a 15 μm-thick aluminum foil without a current collector coating layer was used as a positive electrode collector.

### Examples 1 to 12

Examples 1 to 5 are implementation of the present invention, while Examples 6 to 12 are comparative examples.

A positive electrode active material layer was formed by the following method.

With the blending ratio shown in Table 1, the positive electrode active material particles, the conducting agent, the binder, and N-methyl pyrrolidone as a solvent were mixed with a mixer to obtain a positive electrode composition. The amount of the solvent used was the amount required for applying the positive electrode composition. The blending amounts of the positive electrode active material particles, the conducting agent, the binder and the dispersant in the table are percentage values relative to the total 100% by mass excluding the solvent, that is, the total amount of the positive electrode active material particles, the conducting agent, the binder, and the dispersant.

The obtained positive electrode composition was applied to both surfaces of the positive electrode current collector, and after pre-drying, the applied composition was vacuum-dried at 120° C. to form positive electrode active material layers. The total coating amount of the positive electrode composition on both sides of the positive electrode current collector was set to 20.0 mg/cm². The positive electrode active material layers on both surfaces of the positive electrode current collector were formed so as to have the same coating amount and the same thickness. After coating, the coating was pressure-pressed at a line pressure of 10 kN to obtain a positive electrode sheet.

The obtained positive electrode sheet was punched to obtain a positive electrode.

With respect to the obtained positive electrode sheet, the conductive carbon content with respect to the total mass of the positive electrode active material layer was determined. The results are shown in Table 3.

The conductive carbon content with respect to the total mass of the positive electrode active material layer was calculated based on the carbon content and blending amount of the positive electrode active material particles as well as the carbon content and blending amount of the conducting agent. The conductive carbon content can also be confirmed by the <<Method for measuring conductive carbon content>> described above.

A non-aqueous electrolyte secondary battery having a configuration shown in FIG. 2 was manufactured by the following method.

A non-aqueous electrolyte solution was prepared by dissolving lithium hexafluorophosphate as an electrolyte at 1 mol/L and LiFSI as an additive at 0.5 mol/L in a solvent prepared by mixing ethylene carbonate (hereinafter referred to as “EC”) and diethyl carbonate (hereinafter referred to as “DEC”) at a volume ratio, EC:DEC, of 3:7.

As a separator, a polyolefin film having a thickness of 15 μm was used. The positive electrode obtained above and the negative electrode obtained in Production Example 1 were alternately interleaved through a separator to prepare an electrode layered body with its outermost layer being the negative electrode.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery (i.e., laminate cell).

Subsequently, as an initial charge, the laminate cell was charged at a constant current rate of 0.2 C and with a cut-off voltage of 3.6 V, charged at a constant voltage of 3.6 V until the current value dropped to 0.05 C, and then discharged at a constant current rate of 0.2 C and with a cut-off voltage of 2.0 V. Then, the laminate cell was disassembled in an inert atmosphere, and the values of C/M, M/(S+N), and S/N were determined by the above-mentioned <<Method for determining element ratio on the surface of the positive electrode active material layer by XPS>>. The results are shown in Table 2.

Further, the presence or absence of a peak at 280 to 290 eV and the peak intensity ratio (P285/P280) were measured by the above <<TEM-EELS spectrum measurement method for positive electrode active material particles>>. The results are shown in Table 3.

Further, a high-temperature storage test in a fully charged state was performed by the above method for the laminate cell that had been initially charged under the same conditions as above, and the resistance increase rate was measured. The results are shown in Table 3.

TABLE 1

| | Positive electrode composition | | | | |
|---|---|---|---|---|---|
| | Positive electrode active | | Conducting | | |
| | material particles | | agent | Binder | Solvent |
| | | Amount | Amount | Amount | Amount |
| Unit | Type | wt % | wt % | wt % | wt % |

| | | | | |
|---|---|---|---|---|
| Ex. 1 | LFP coated | 99.0 | 0 | Required |
| | particles (1) | | | amount |
| Ex. 2 | LFP coated | 99.0 | 0 | |
| | particles (2) | | | |
| Ex. 3 | LFP coated | 99.0 | 0 | |
| | particles (3) | | | |
| Ex. 4 | LFP coated | 98.5 | 0.5 | |
| | particles (2) | | | |
| Ex. 5 | LFP coated | 98.0 | 1.0 | |
| | particles (4) | | | |
| Ex. 6 | LFP coated | 94.0 | 5.0 | |
| | particles (1) | | | |
| Ex. 7 | LFP coated | 94.0 | 5.0 | |
| | particles (3) | | | |
| Ex. 8 | LFP coated | 99.0 | 0 | |
| | particles (1) | | | |
| Ex. 9 | LFP coated | 99.0 | 0 | |
| | particles (4) | | | |
| Ex. 10 | LFP coated | 99.0 | 0 | |
| | particles (5) | | | |
| Ex. 11 | NCA particles(1) | 95.0 | 4.0 | |
| Ex. 12 | NCA particles(1) | 95.0 | 4.0 | |

TABLE 2

| | XPS measurement of the positive electrode active material layer surface | | | | | | | | |
|---|---|---|---|---|---|---|---|---|---|
| | Peak intensity (Atomic conc. %) | | | | | | Element ratio on positive | | |
| | Metal M | | | | | | electrode surface | | |
| | Fe (2p) | Ni(2p) | Al (2p) | C (1s) | S(2p) | N(1s) | C/M | M/(S + N) | S/N |
| Ex. 1 | 4.0 | — | — | 29.0 | 0.9 | 1.2 | 7.3 | 1.9 | 0.8 |
| Ex. 2 | 3.8 | — | — | 40.4 | 0.6 | 0.9 | 10.6 | 2.5 | 0.7 |
| Ex. 3 | 3.4 | — | — | 45.0 | 0.3 | 0.6 | 13.2 | 3.8 | 0.5 |
| Ex. 4 | 3.0 | — | — | 43.6 | 1.1 | 1.5 | 14.5 | 1.2 | 0.7 |
| Ex. 5 | 3.5 | — | — | 31.2 | 1.1 | 1.6 | 8.9 | 1.3 | 0.7 |
| Ex. 6 | 1.7 | — | — | 53.9 | 2.2 | 3.1 | 31.7 | 0.3 | 0.7 |
| Ex. 7 | 1.7 | — | — | 52.1 | 3.1 | 4.4 | 30.6 | 0.2 | 0.7 |
| Ex. 8 | 3.6 | — | — | 44.3 | 0.4 | 0.7 | 12.3 | 3.3 | 0.6 |
| Ex. 9 | 6.1 | — | — | 14.9 | 2.1 | 5.6 | 2.4 | 0.8 | 0.4 |
| Ex. 10 | 3.6 | — | — | 28.8 | 8.3 | 7.1 | 8.0 | 0.2 | 1.2 |
| Ex. 11 | — | 1.8 | 0.4 | 49.7 | 5.6 | 3.7 | 22.2 | 0.2 | 1.5 |
| Ex. 12 | — | 1.7 | 0.5 | 50.1 | 4.3 | 3.3 | 22.8 | 0.3 | 1.3 |

In Table 2, “—” indicates a value below the lower limit (0.1).

TABLE 3

| | | | | | Conductive | | | | | | | |
|---|---|---|---|---|---|---|---|---|---|---|---|---|
| | XPS | | | | carbon | TEM-EELS measurement | | | | 75° C.- storage test in a fully | | |
| | measurement | | Coating | | content | of positive electrode active | | | | charged state | | |
| | of the positive | | section of | | of positive | material particles | | | | | | |
| | electrode active | | positive | | electrode | Presence | | Type of | | AC 1 kHz | | |
| | material layer | | electrode | Conducting | active | or absence | Peak | positive | Current | Resistance | | Resistance |
| | surface | | active | agent | material | of a peak | intensity | electrode | collector | value [mΩ] | | increase |
| | | M/ | material | content | layer | at 280 | ratio | active | coating | Before | After | rate |
| | C/M | (S + N) | particles | [wt %] | [wt %] | to 290 eV | P₂₈₅/P₂₈₀ | material | layer | storage | storage | [%] |
| Ex. 1 | 7.3 | 1.9 | Present | 0.0 | 1.5 | Present | 38 | LFP | Present | 10.8 | 12.9 | 119 |
| Ex. 2 | 10.6 | 2.5 | Present | 0.0 | 2.0 | Present | 42 | LFP | Present | 10.5 | 11.8 | 112 |
| Ex. 3 | 13.2 | 3.8 | Present | 0.0 | 2.5 | Present | 47 | LFP | Present | 10.1 | 10.4 | 103 |
| Ex. 4 | 14.5 | 1.2 | Present | 0.5 | 2.5 | Present | 46 | LFP | Present | 9.9 | 12.0 | 121 |
| Ex. 5 | 8.9 | 1.3 | Present | 1.0 | 1.5 | Absent | — | LFP | Present | 12.4 | 15.7 | 127 |
| Ex. 6 | 31.7 | 0.3 | Present | 5.0 | 6.5 | Present | 37 | LFP | Present | 10.7 | 17.8 | 166 |
| Ex. 7 | 30.6 | 0.2 | Present | 5.0 | 6.5 | Present | 38 | LFP | Absent | 41.1 | 76.0 | 185 |
| Ex. 8 | 12.3 | 3.3 | Present | 0.0 | 2.5 | Present | 48 | LFP | Absent | 82.7 | 172.8 | 209 |
| Ex. 9 | 2.4 | 0.8 | Present | 0.0 | 0.5 | Absent | — | LFP | Present | 25.6 | 54.3 | 212 |
| Ex. | 8.0 | 0.2 | Present | 0.0 | 1.5 | Present | 17 | LFP | Present | 15.0 | 25.4 | 169 |
| 10 | | | | | | | | | | | | |
| Ex. | 22.2 | 0.2 | Absent | 4.0 | 4.0 | Absent | — | NCA | Present | 22.4 | 53.8 | 240 |
| 11 | | | | | | | | | | | | |
| Ex. | 22.8 | 0.3 | Absent | 4.0 | 4.0 | Absent | — | NCA | Absent | 31.5 | 107.4 | 341 |
| 12 | | | | | | | | | | | | |

As can be understood from the results shown in Table 3, in Examples 1 to 5 where C/M was 3.0 to 15.0 and M/(S+N) was 1.0 to 5.0, the resistance increase rate after the storage test was kept low.

The comparison between Examples 1 to 3 shows that, as the amount of conductive carbon present in the coating section of the positive electrode active material particles increased, the amount of coating decreased, the value of M/(S+N) increased, and the resistance increase rate decreased.

The comparison between Example 3 and Example 4 shows that the conductive carbon content relative to the total mass of the positive electrode active material layer was the same, but Example 4 with a conducting agent resulted in a higher C/M. Example 3 without a conducting agent and with a larger amount of conductive carbon in the coating section resulted in a higher M/(S+N) value, a smaller amount of coating, and a lower resistance increase rate. It is presumed that the conducting agent has a larger surface area and higher reactivity than the conductive carbon in the coating section, which tends to result in a larger amount of coating.

In Examples 6 and 7, due to the large amount of conducting agent, C/M was high and M/(S+N) was low, so that the amount of coating was large and the resistance increase rate was high. It is presumed that LiFSI was decomposed excessively.

Comparing Example 6 and Example 7, Example 6 with a current collector coating layer showed a higher M/(S+N), a smaller amount of coating, and a lower resistance increase rate. It is presumed that LiFSI was easily decomposed on the current collector surface in Example 7 without a current collector coating layer.

In Example 8, compared to Example 3, there was no current collector coating layer, C/M was low and M/(S+N) was low, so that the amount of coating was large and the resistance increase rate was high. It is presumed that LiFSI was decomposed excessively.

In Example 9, compared to Example 1, the peaks representing the coating section of the positive electrode active material particles in the TEM-EELS spectrum were insufficient, M/(S+N) was low, the amount of coating was large, and the resistance increase rate was high. It is presumed that LiFSI was easily decomposed on the surface of the positive electrode active material particles.

Example 10 showed a higher sulfur peak intensity than those of the other examples, which was higher than the nitrogen peak intensity. It is highly likely that the positive electrode active material particles, i.e., the LFP-coated particles (5), themselves contained sulfur as an impurity in advance, and the amount of sulfur contained was presumably such that the formation of a decomposition coating of LiFSI was inhibited. For this reason, M/(S+N) was low and the resistance increase rate was high. It is presumed that the coating was not formed desirably on the surface of the positive electrode active material layer, and the decomposition coating of LiFSI was insufficient.

In Examples 11 and 12, which are examples using nickel-based positive electrode active materials, C/M was high and M/(S+N) was low, so that the amount of coating was large and the resistance increase rate was high. It is presumed that LiFSI was excessively decomposed because the potential of the positive electrode active material particles was high and the reactivity on the particle surface was high.

Comparing Example 11 and Example 12, Example 12 without a current collector coating layer showed a lower M/(S+N) and a higher resistance increase rate. It is presumed that LiFSI was decomposed excessively not only on the surface of the positive electrode active material particles but also on the surface of the current collector.

### EXPLANATION OF REFERENCE NUMERALS

1 Positive electrode
2 Separator
3 Negative electrode
4 Non-aqueous electrolyte solution
5 Outer casing
10 Secondary battery
11 Positive electrode current collector
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector

1. A non-aqueous electrolyte secondary battery, comprising a positive electrode, a negative electrode, and a non-aqueous electrolyte solution disposed between the positive electrode and the negative electrode, wherein:
the positive electrode comprises a current collector and a positive electrode active material layer provided on the current collector,
the current collector has, on at least a part of its surface on a side of the positive electrode active material layer, a current collector coating layer comprising a conductive material,
the positive electrode active material layer comprises positive electrode active material particles and a conductive carbon, and
the positive electrode active material layer has surface element ratios wherein C/M, which represents a ratio of carbon element C to metal element M excluding Group 1 elements and Group 2 elements of the periodic table, is 3.0 to 15.0, and M/(S+N), which represents a ratio of the metal element M to a sum of sulfur element S and nitrogen element N, is 1.0 to 5.0.

2. The non-aqueous electrolyte secondary battery according to claim 1, wherein the positive electrode active material particles comprise coated particles having a core section formed of a positive electrode active material and a coating section containing a conductive material.

3. The non-aqueous electrolyte secondary battery according to claim 2, wherein the conductive material of the coating section comprises carbon.

4. The non-aqueous electrolyte secondary battery according to claim 1, wherein the positive electrode active material particles, on surfaces thereof, the coating section which has a peak in a range of 280 to 290 eV in a TEM-EELS spectrum resulting from combination of a transmission electron microscope (TEM) with electron energy loss spectroscopy (EELS), and has a ratio P₂₈₅/P₂₈₀ of 10.0 or more, which is a ratio of a peak intensity P₂₈₅ at 285 eV to a peak intensity P₂₈₀ at 280 eV in the TEM-EELS spectrum.

5. The non-aqueous electrolyte secondary battery according to claim 1, wherein, with respect to the surface element ratios, S/N, which represents a ratio of sulfur element S to nitrogen element N, is 0.01 to 1.00.

6. The non-aqueous electrolyte secondary battery according to claim 1, wherein the positive electrode active material layer comprises a conducting agent.

7. The non-aqueous electrolyte secondary battery according to claim 1, wherein an amount of the conductive carbon is 0.5% by mass or more and less than 3.0% by mass, based on a total mass of the positive electrode active material layer.

8. The non-aqueous electrolyte secondary battery according to claim 1, wherein the positive electrode active material particles comprise a compound represented by a formula LiFeₓM₍₁₋ₓ₎PO₄, wherein 0≤x≤1, M is Co, Ni, Mn, Al, Ti or Zr.

9. The non-aqueous electrolyte secondary battery according to claim 1, wherein the conductive material of the current collector coating layer comprises carbon.

10. A battery module or battery system comprising a plurality of the non-aqueous electrolyte secondary batteries of claim 1.
